(19) United States
(12) Patent Application Publication
(10) Pub. No.: US 2026/0340942 A1
(43) Pub. Date: Oct. 29, 2026

(54) METHOD AND APPARATUS FOR MEASURING CARGO

(71) Applicants: Hyundai Motor Company, Seoul (KR); Kia Corporation, Seoul (KR)

(72) Inventors: Jae Seung Jun, Hwaseong (KR); Minkooc Wee, Hwaseong (KR); Se Do Oh, Hwaseong (KR); You Jin Shin, Hwaseong (KR)

(21) Appl. No.: 19/425,612

(22) Filed: Dec. 18, 2025

(30) Foreign Application Priority Data
Apr. 25, 2025 (KR) 10-2025-0054333

(51) Int. Cl. G06T 17/20; G06T 7/50

(52) U.S. Cl. CPC G06T 17/20; G06T 7/50; G06T 2207/10028; G06T 2207/20081; G06T 2207/20084

(57) ABSTRACT

A method for measuring cargo may include obtaining a plurality of raw point clouds corresponding to the cargo measured by the multi-sensor-based cargo measuring device, generating a single aligned point cloud by matching the plurality of raw point clouds to a single space, determining an operation mode for removing an outlier from the aligned point cloud, setting a plurality of sections in the aligned point cloud, depending on the determined operation mode, determining of a first section including the largest number of points, from among the plurality of sections, and determining a second section adjacent to the first section and having no point, generating a refined point cloud from which the outlier is removed, reconstructing a final model by inputting the refined point cloud into a deep learning model, causing the deep learning model to predict a 3D mesh, and performing a measurement with respect to the cargo.

### CROSS-REFERENCE TO RELATED APPLICATION

This application claims, under 35 U.S.C. §119(a), the benefit of Korean Patent Application No. 10-2025-0054333, filed Apr. 25, 2025, with the Korean Intellectual Property Office, the entire contents of which are incorporated herein by reference.

### BACKGROUND

### a. Technical Field

The present disclosure relates to a method and apparatus for measuring cargo and, more particularly, to a method and apparatus for measuring cargo capable of measuring large cargo accurately and quickly by removing outliers from a 3D point cloud of large cargo extracted from a large cargo measuring device.

### b. Background

In the modern logistics and air transportation industries, when large cargo is delivered to a cargo terminal, it is essential to accurately measure the weight, volume, length, height, and shape of the cargo. Such information plays an important role in calculating the cost of transporting the cargo and determining the loading sequence and position on the aircraft. However, there are several difficulties in accurately calculating the volume of large cargo.

Currently, workers use internal guidelines to stack, group, and package box-type loads. For regular cargo, the volume may be measured manually by using a tape measure, but the measurement results may vary depending on the skill of the worker. For irregular objects, volume measurement is more difficult. This type of manual method causes errors in calculating freight rates and is particularly problematic for calculating freight rates for irregular cargo, as accurate volume measurement is difficult. Existing measuring devices calculate box volume by considering the outermost part of large cargo as a rectangular parallelepiped, which has the problem of high error rate in volume measurement for irregular cargo or skid-mounted cargo, resulting in overcharges.

In addition, there may be a deviation in time and packaging results as workers manually package cargo according to internal guidelines. This deviation requires repackaging during aircraft loading, which reduces overall work efficiency. In particular, it may be difficult to determine the loading sequence due to the irregular shapes of the cargo and the unique structure with a rounded roof of the cargo space, which results in suboptimal loading, creating empty spaces and leading to cost losses.

The above information disclosed in this Background section is only for enhancement of understanding of the background of the present disclosure, and therefore it may contain information that does not form the related art that is already known to one having ordinary skill in the art.

### SUMMARY

The present disclosure attempts to provide a method and apparatus for measuring cargo capable of measuring large cargo accurately and quickly by removing outliers from a 3D point cloud of large cargo extracted from a large cargo measuring device.

A method for measuring cargo, performed by a computing device including a processor and a memory, may include connecting, by the processor, to a multi-sensor-based cargo measuring device provided with a plurality of 3D depth sensors, obtaining, by the processor, a plurality of raw point clouds corresponding to the cargo measured by the multi-sensor-based cargo measuring device, generating, by the processor, a single aligned point cloud by matching the plurality of raw point clouds to a single space, determining, by the processor, an operation mode for removing an outlier from the aligned point cloud, setting, by the processor, a plurality of sections in the aligned point cloud, depending on the determined operation mode, determining, by the processor, of a first section including the largest number of points, from among the plurality of sections, and determining a second section adjacent to the first section and having no point, generating, by the processor, a refined point cloud from which the outlier is removed based on based on the first section and the second section, reconstructing, by the processor, a final model by inputting the refined point cloud into a deep learning model, and causing the deep learning model to predict a 3D mesh, and performing, by the processor, a measurement with respect to the cargo by using the final model.

The determining the operation mode may include determining, by the processor, the operation mode as a first operation mode, where the setting the plurality of sections may include setting, by the processor, of a portion of the aligned point cloud as a region-of-interest, determining, by the processor, a center point corresponding to a position average of all points belonging to the region-of-interest, and setting, by the processor, a plurality of radial sections, based on the center point.

The setting the plurality of radial sections may include setting, by the processor, of a first intermediate section, through division into preset units of a first parameter unit in a phi direction, based on the center point, and setting, by the processor, a plurality of second intermediate sections by dividing the first intermediate section into preset units of a second parameter based on a rho value.

The determining the first section may include determining, by the processor, the second intermediate section including the largest number of points, among the plurality of second intermediate sections as the first section.

The generating the refined point cloud may include determining, by the processor, that a second intermediate section among the plurality of second intermediate sections, which lies after the first section and the second section, and which may include fewer points than a predetermined threshold value, may include the outlier, and removing, by the processor, a point included in the second intermediate section determined to include the outlier.

The determining the operation mode may include determining, by the processor, the operation mode as a second operation mode, where the setting the plurality of sections may include determining, by the processor, a center point corresponding to a position average of all points belonging to the aligned point cloud, and setting, by the processor, the plurality of sections in a cylindrical shape, based on a straight line passing through the center point.

The setting the plurality of sections of the cylindrical shape may include setting, by the processor, a plurality of first intermediate sections through division into units of a first parameter in a vertical direction along a straight line passing through the center point, and setting, by the processor, a plurality of second intermediate sections by dividing the first intermediate section into preset units of a second parameter in a horizontal direction.

The determining the first section may include determining, by the processor, the second intermediate section including the largest number of points, among the plurality of second intermediate sections as the first section.

The generating the refined point cloud may include determining, by the processor, that a second intermediate section among the plurality of second intermediate sections, which lies after the first section and the second section, and which may include fewer points than a predetermined threshold value, may include the outlier, and removing, by the processor, a point included in the second intermediate section determined to include the outlier.

The generating the refined point cloud may include determining, by the processor, a first external section that is adjacent to the first intermediate section corresponding to an outer side in an external direction and may include no point, with respect to a first intermediate section corresponding to an outer side among the plurality of first intermediate sections, determining, by the processor, that a second external section that lies after the second section and may include fewer points than a predetermined threshold value may include the outlier, and removing, by the processor, a point included in the second external section determined to include the outlier.

An apparatus for measuring cargo may include one or more non-transitory computer-readable media including an instruction, and one or more processors configured to perform an operation by executing the instruction, where the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, determining an operation mode for removing an outlier from the aligned point cloud, setting a plurality of sections in the aligned point cloud, depending on the determined operation mode, determining a first section including the largest number of points, from among the plurality of sections, determining a second section adjacent to the first section and having no point, generating a refined point cloud from which the outlier is removed based on based on the first section and the second section, reconstructing a final model by inputting the refined point cloud into a deep learning model, and causing the deep learning model to predict a 3D mesh, and performing a measurement with respect to the cargo by using the final model.

The determining the operation mode may include determining the operation mode as a first operation mode, where the setting the plurality of sections may include setting a portion of the aligned point cloud as a region-of-interest, determining a center point corresponding to a position average of all points belonging to the region-of-interest, and setting a plurality of radial sections, based on the center point.

The setting the plurality of radial sections may include setting a first intermediate section, through division into preset units of a first parameter unit in a phi direction, based on the center point, and setting a plurality of second intermediate sections by dividing the first intermediate section into preset units of a second parameter based on a rho value.

The determining the first section may include determining the second intermediate section including the largest number of points, among the plurality of second intermediate sections as the first section.

The generating the refined point cloud may include determining that a second intermediate section among the plurality of second intermediate sections, which lies after the first section and the second section, and which may include fewer points than a predetermined threshold value, may include the outlier, and removing a point included in the second intermediate section determined to include the outlier.

The determining the operation mode may include determining the operation mode as a second operation mode, where the setting the plurality of sections may include determining a center point corresponding to a position average of all points belonging to the aligned point cloud, and setting the plurality of sections in a cylindrical shape, based on a straight line passing through the center point.

The setting the plurality of sections of the cylindrical shape may include setting a plurality of first intermediate sections through division into units of a first parameter in a vertical direction along a straight line passing through the center point, and setting a plurality of second intermediate sections by dividing the first intermediate section into preset units of a second parameter in a horizontal direction.

The determining the first section may include determining the second intermediate section including the largest number of points, among the plurality of second intermediate sections as the first section.

The generating the refined point cloud may include determining that a second intermediate section among the plurality of second intermediate sections, which lies after the first section and the second section, and which may include fewer points than a predetermined threshold value, may include the outlier, and removing a point included in the second intermediate section determined to include the outlier.

One or more non-transitory computer-readable media may include an instruction executable by a computing device, where the instruction causes the computing device to perform an operation when executed by one or more processors of the computing device, and the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, determining an operation mode for removing an outlier from the aligned point cloud, setting a plurality of sections in the aligned point cloud, depending on the determined operation mode, determining a first section including the largest number of points, from among the plurality of sections, determining a second section adjacent to the first section and having no point, generating a refined point cloud from which the outlier is removed based on based on the first section and the second section, reconstructing a final model by inputting the refined point cloud into a deep learning model, and causing the deep learning model to predict a 3D mesh, and performing a measurement with respect to the cargo by using the final model.

According to an aspect of the present disclosure, a method for measuring cargo is provided. The method may comprise, using a computing device comprising a processor and a memory, obtaining a plurality of raw point clouds corresponding to cargo measured by a multi-sensor-based cargo measuring device provided with a plurality of 3D depth sensors, generating a single aligned point cloud by matching the plurality of raw point clouds to a single space, determining an operation mode for removing an outlier from the aligned point cloud, setting a plurality of sections in the aligned point cloud, depending on the determined operation mode, determining a first section including a largest number of points, from among the plurality of sections, determining a second section adjacent to the first section and having no points, generating a refined point cloud from which the outlier is removed based on based on the first section and the second section, reconstructing a final model by inputting the refined point cloud into a deep learning model, causing the deep learning model to predict a 3D mesh, and performing a measurement with respect to the cargo by using the final model.

According to an exemplary embodiment, the determining the operation mode may comprise determining the operation mode as a first operation mode, and the setting the plurality of sections may comprise setting a portion of the aligned point cloud as a region-of-interest, determining a center point corresponding to a position average of all points belonging to the region-of-interest, and setting a plurality of radial sections, based on the center point.

According to an exemplary embodiment, the setting the plurality of radial sections may comprise setting of a first intermediate section, through division into preset units of a first parameter unit in a phi direction, based on the center point and setting a plurality of second intermediate sections by dividing the first intermediate section into preset units of a second parameter based on a rho value.

According to an exemplary embodiment, the determining the first section may comprise determining the second intermediate section including the largest number of points, among the plurality of second intermediate sections as the first section.

According to an exemplary embodiment, the generating the refined point cloud may comprise determining that a second intermediate section among the plurality of second intermediate sections, which lies after the first section and the second section, and which comprises fewer points than a predetermined threshold value, includes the outlier, and removing a point included in the second intermediate section determined to include the outlier.

According to an exemplary embodiment, the determining the operation mode may comprise determining the operation mode as a second operation mode, and the setting the plurality of sections may comprise determining a center point corresponding to a position average of all points belonging to the aligned point cloud, and setting the plurality of sections in a cylindrical shape, based on a straight line passing through the center point.

According to an exemplary embodiment, the setting the plurality of sections of the cylindrical shape may comprise setting a plurality of first intermediate sections through division into units of a first parameter in a vertical direction along a straight line passing through the center point, and setting a plurality of second intermediate sections by dividing the first intermediate section into preset units of a second parameter in a horizontal direction.

According to an exemplary embodiment, the determining the first section may comprise determining the second intermediate section including the largest number of points, among the plurality of second intermediate sections as the first section.

According to an exemplary embodiment, the generating the refined point cloud may comprise determining that a second intermediate section among the plurality of second intermediate sections, which lies after the first section and the second section, and which comprises fewer points than a predetermined threshold value, includes the outlier, and removing a point included in the second intermediate section determined to include the outlier.

According to an exemplary embodiment, the generating the refined point cloud may comprise determining a first external section that is adjacent to the first intermediate section corresponding to an outer side in an external direction and includes no point, with respect to a first intermediate section corresponding to an outer side among the plurality of first intermediate sections, determining that a second external section that lies after the second section and comprises fewer points than a predetermined threshold value includes the outlier, and removing a point included in the second external section determined to include the outlier.

According to an aspect of the present disclosure, an apparatus for measuring cargo is provided. The apparatus may comprise a computing device, comprising a processor and a memory, the computing device being configured to obtain a plurality of raw point clouds corresponding to cargo measured by a multi-sensor-based cargo measuring device provided with a plurality of 3D depth sensors, generate a single aligned point cloud by matching the plurality of raw point clouds to a single space, determine an operation mode for removing an outlier from the aligned point cloud, set a plurality of sections in the aligned point cloud, depending on the determined operation mode, determine a first section including the largest number of points, from among the plurality of sections, determine a second section adjacent to the first section and having no point, generate a refined point cloud from which the outlier is removed based on based on the first section and the second section, reconstruct a final model by inputting the refined point cloud into a deep learning model, and causing the deep learning model to predict a 3D mesh, and perform a measurement with respect to the cargo by using the final model.

According to an exemplary embodiment, the determining the operation mode may comprise determining the operation mode as a first operation mode, and the setting the plurality of sections may comprise setting a portion of the aligned point cloud as a region-of-interest, determining a center point corresponding to a position average of all points belonging to the region-of-interest, and setting a plurality of radial sections, based on the center point.

According to an exemplary embodiment, the setting the plurality of radial sections may comprise setting a first intermediate section, through division into preset units of a first parameter unit in a phi direction, based on the center point, and setting a plurality of second intermediate sections by dividing the first intermediate section into preset units of a second parameter based on a rho value.

According to an exemplary embodiment, the determining the first section may comprise determining the second intermediate section including the largest number of points, among the plurality of second intermediate sections as the first section.

According to an exemplary embodiment, the generating the refined point cloud may comprise determining that a second intermediate section among the plurality of second intermediate sections, which lies after the first section and the second section, and which comprises fewer points than a predetermined threshold value, includes the outlier, and removing a point included in the second intermediate section determined to include the outlier.

According to an exemplary embodiment, the determining the operation mode may comprise determining the operation mode as a second operation mode, and the setting the plurality of sections may comprise determining a center point corresponding to a position average of all points belonging to the aligned point cloud, and setting the plurality of sections in a cylindrical shape, based on a straight line passing through the center point.

According to an exemplary embodiment, the setting the plurality of sections of the cylindrical shape may comprise setting a plurality of first intermediate sections through division into units of a first parameter in a vertical direction along a straight line passing through the center point, and setting a plurality of second intermediate sections by dividing the first intermediate section into preset units of a second parameter in a horizontal direction.

According to an exemplary embodiment, the determining the first section may comprise determining the second intermediate section including the largest number of points, among the plurality of second intermediate sections as the first section.

According to an exemplary embodiment, the generating the refined point cloud may comprise determining that a second intermediate section among the plurality of second intermediate sections, which lies after the first section and the second section, and which comprises fewer points than a predetermined threshold value, includes the outlier, and removing a point included in the second intermediate section determined to include the outlier.

According to an aspect of the present disclosure, a computing device is provided. The computing device may comprise a processor and a memory. The memory may be configured to store instructions that, when executed by the processor, are configured to cause the processor to obtain a plurality of raw point clouds corresponding to cargo measured by a multi-sensor-based cargo measuring device provided with a plurality of 3D depth sensors, generate a single aligned point cloud by matching the plurality of raw point clouds to a single space, determine an operation mode for removing an outlier from the aligned point cloud, set a plurality of sections in the aligned point cloud, depending on the determined operation mode, determine a first section including the largest number of points, from among the plurality of sections, determine a second section adjacent to the first section and having no points, generate a refined point cloud from which the outlier is removed based on based on the first section and the second section, reconstruct a final model by inputting the refined point cloud into a deep learning model, and causing the deep learning model to predict a 3D mesh, and perform a measurement with respect to the cargo by using the final model.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a drawing for explaining an apparatus for measuring cargo, according to an exemplary embodiment of the present disclosure.

FIG. 2 illustrates a drawing for explaining a method for measuring cargo, according to an exemplary embodiment of the present disclosure.

FIGS. 3 and 4 illustrate drawings for explaining a method for measuring cargo, according to an exemplary embodiment of the present disclosure.

FIG. 5 illustrates a drawing for explaining a method for measuring cargo, according to an exemplary embodiment of the present disclosure.

FIGS. 6-11 illustrate drawings for explaining implementation examples of a method and apparatus for measuring cargo, according to an exemplary embodiment of the present disclosure.

FIG. 12 illustrates a drawing for explaining a computing device, according to an exemplary embodiment of the present disclosure.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Throughout the specification and claims, when a part "includes" a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

In addition, terms such as "... part," "... portion," " ... er/or," or "module" disclosed in the present specification may mean a unit that may process at least one function or operation described in this specification, and this may be implemented by hardware, software, or a combination thereof. Additionally, at least some of the configurations or functions of the method and apparatus for measuring cargo according to the embodiments described below may be implemented as a program or software, and the program or software may be stored in a computer-readable medium.

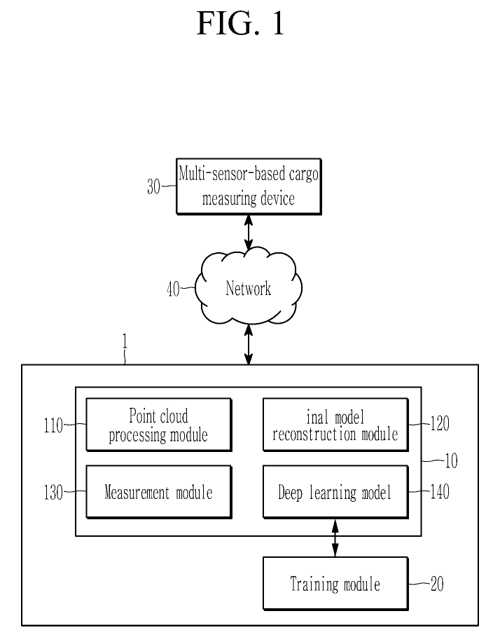

FIG. 1 illustrates a drawing for explaining an apparatus for measuring cargo, according to an embodiment.

Referring to FIG. 1, a system 1 for measuring cargo, according to an exemplary embodiment, may comprise an apparatus 10 configured to measure cargo, a training module 20, and a multi-sensor-based cargo measuring device 30. The apparatus 10 for measuring cargo and the multi-sensor-based cargo measuring device 30 may be configured to exchange data with each other through a network 40, and the training module 20 may be configured to train a deep learning model 140 used in the apparatus 10 for measuring cargo by using a preset training data. In FIG. 1, the training module 20 is illustrated as an element implemented outside the apparatus 10 for measuring cargo, but depending on specific implementation purpose or environment, the training module 20 may be implemented inside the apparatus 10 for measuring cargo, or although not shown, may be implemented on a remote server. When implemented on a remote server, the apparatus 10 for measuring cargo may be provided with the deep learning model 140 for which training is completed, from a remote server through the network 40.

The multi-sensor-based cargo measuring device 30 may comprise a plurality of 3D depth sensors. The plurality of 3D depth sensors, each viewing the cargo from different angles, may be used to obtain a point cloud of the cargo. A plurality of raw point clouds may be obtained through the plurality of 3D depth sensors. On the other hand, the multi-sensor-based cargo measuring device 30 may be further provided with a plurality of vision cameras. The plurality of vision cameras, each viewing the cargo from different angles, may be used to obtain an image of the cargo. A plurality of raw images may be obtained through the plurality of vision cameras. The multi-sensor-based cargo measuring device 30 may be configured to provide the plurality of raw point clouds and the plurality of raw images obtained in that way to the apparatus 10 for measuring cargo, through the network 40.

According to an exemplary embodiment, the number of 3D depth sensors and the number of vision cameras, used in the multi-sensor-based cargo measuring device 30, may be set to be different from each other. According to an exemplary embodiment, the number of vision cameras may be set to greater than the number of 3D depth sensors. For example, in the multi-sensor-based cargo measuring device 30, six vision cameras may be used, while four 3D depth sensors may be used.

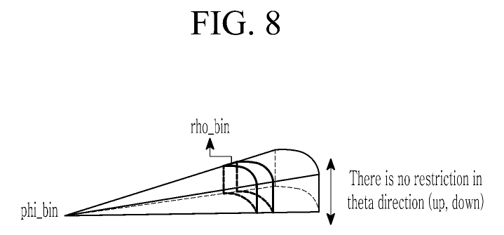

The apparatus 10 for measuring cargo, according to an exemplary embodiment, may be implemented as a computing device comprising a processor and a memory. For example, the apparatus 10 for measuring cargo may comprise a computing device 50, such as that described later with reference to FIG. 8. In this case, processor may correspond to a processor 510 of the computing device 50, and memory may correspond to a memory 520 of the computing device 50. Alternatively, according to an exemplary embodiment, the apparatus 10 for measuring cargo may comprise one or more non-transitory computer-readable media including an instruction and one or more processors configured to perform an operation by executing the instruction. Here, the operation may comprise the configuration, function, step, or the like explained in this specification with respect to a method and apparatus for measuring cargo according to embodiments. In this specification, the term “module” is used in order to logically differentiate these operations performed by a model compression method and apparatus according to embodiments.

The apparatus 10 for measuring cargo may comprise a point cloud processing module 110, a final model reconstruction module 120, a measurement module 130 and the deep learning model 140.

The point cloud processing module 110 may be connected to the multi-sensor-based cargo measuring device 30, and may be configured to obtain the plurality of raw point clouds corresponding to the cargo measured by the multi-sensor-based cargo measuring device 30. For example, if the multi-sensor-based cargo measuring device 30 uses four 3D depth sensors, the point cloud processing module 110 may be configured to obtain four raw point clouds corresponding to each.

The point cloud processing module 110 may be configured to generate a single aligned point cloud by matching the raw point cloud to a single space. This is known as point cloud registration, and may involve aligning the plurality of raw point clouds to a common coordinate system to generate a single, consistent data set. According to an exemplary embodiment, the point cloud processing module 110 may be configured to precisely align point clouds by first performing rough alignment by extracting feature points from the raw point cloud and finding corresponding points, and then repeatedly matching the nearest neighbors between points in each point cloud and minimizing the distance between the matched points. Additionally, a transformation matrix including rotation, translation, and scaling may be applied to each point cloud. When the plurality of raw point clouds are merged into a single common coordinate system, they may share the same reference frame, and during this process, the relative position and direction of each cloud may be adjusted.

The point cloud processing module 110 may be configured to perform preprocessing on the aligned point cloud, to generate a refined point cloud.

According to an exemplary embodiment, the point cloud processing module 110 may be configured to apply a plurality of point cloud samplings to the aligned point cloud. Here, the point cloud sampling may refer to selecting some points from a point cloud to adjust the density of data or improve processing efficiency. The point cloud processing module 110 may be configured to use two or more point cloud sampling techniques rather than just one point cloud sampling technique.

According to an exemplary embodiment, the point cloud sampling may comprise random sampling, voxel sampling, and uniform sampling. For example, the point cloud processing module 110 may be configured to perform point cloud sampling by using random sampling and voxel sampling, and the user may appropriately adjust the usage proportion of each of random sampling and voxel sampling through predetermined parameters. By adopting the above-described method, more points may be selected in regions where more points are collected, and fewer points may be selected in regions where fewer points are collected.

On the other hand, in some embodiments, the point cloud processing module 110 may be configured to separate the cargo and a bottom surface supporting the cargo from the aligned point cloud, and may be configured to precisely separate a boundary between the cargo and the bottom surface, with respect to a lower portion of the cargo that is not easily distinguished from the bottom surface. Subsequently, the point cloud processing module 110 may be configured to perform a task of removing the bottom surface from the aligned point cloud and leaving only the cargo.

In general, the point cloud data comprises both cargo and the bottom surface, so a process of distinguishing the two elements may be required. In particularly, when the lower portion of the cargo is close to the bottom surface and the boundary is unclear, the point cloud processing module 110 may be configured to accurately identify the shape and position of the cargo by precisely separating the boundary between the cargo and the bottom surface. The point cloud processing module 110 may be configured to apply an algorithm that separates the cargo and the bottom surface, to perform the task of effectively detecting the bottom surface, and removing the bottom surface portion from the aligned point cloud, thereby leaving only the cargo. The above-described process may comprise a data refining step for volume measurement or shape analysis of the cargo, ultimately enabling accurate measurement and analysis. The bottom surface removal work may correspond to an important feature that reduces the complexity of point cloud data and allowing subsequent processing to focus solely on the cargo.

According to an exemplary embodiment, the point cloud processing module 110 may be configured to set a threshold value based on a distance between the cargo and the bottom surface, and may be configured to perform precise separation, by additionally identifying a point corresponding to the bottom surface based on the threshold value. For example, the point cloud processing module 110 may be configured to analyze a position of each point, determine that a point within the threshold value range belongs to the bottom surface, and classify that point as the bottom surface. In this way, the points belonging to the bottom surface may be accurately identified even in the lower region of the cargo where the boundary with respect to the bottom surface is vague, enabling precise separation between the cargo and the bottom surface.

According to an exemplary embodiment, in order to divide the bottom surface, the point cloud processing module 110 may be configured to extract the bottom surface by a Random Sample Consensus (RANSAC) algorithm, and may be configured to divide the cargo based on the bottom surface. By adopting the RANSAC algorithm, a random point may be selected from the point cloud, to generate a plane model corresponding to the bottom surface, the points that fits well to the plane model may be identified as inliers to extract only the points constituting the bottom surface, and other points may be classified as the outliers and separated into cargo.

The point cloud processing module 110 may be configured to additionally remove outliers remaining after dividing the bottom surface and the cargo. To this end, the point cloud processing module 110 may be configured to determine an operation mode for removing the outliers from the aligned point cloud. Here, the operation mode may comprise a first operation mode and a second operation mode. In addition, the point cloud processing module 110 may be configured to set a plurality of sections in the aligned point cloud, depending on the determined the operation mode.

According to an exemplary embodiment, the point cloud processing module 110 may be configured to determine the operation mode as the first operation mode. The point cloud processing module 110 may be configured to set a portion of the aligned point cloud as a region-of-interest, determine a center point corresponding to a position average of all point belonging to the region-of-interest, and set a plurality of radial sections, based on the center point.

In more detail, the point cloud processing module 110 may be configured to set a first intermediate section through division into units of a preset first parameter in a phi direction, based on the center point. In addition, the point cloud processing module 110 may be configured to set a plurality of second intermediate sections by dividing the first intermediate section into preset units of a second parameter based on a rho value.

The point cloud processing module 110 may be configured to determine a first section including the largest number of points among the plurality of sections, and may be configured to determine a second section adjacent to the first section and having no point. Specifically, in some embodiments, the point cloud processing module 110 may be configured to determine a second intermediate section including the largest number of points among the plurality of second intermediate sections as the first section.

The point cloud processing module 110 may be configured to generate the refined point cloud from which outlier is removed based on based on the first section and the second section. Specifically, according to an exemplary embodiment, the point cloud processing module 110 may be configured to determine that a second intermediate section among the plurality of second intermediate sections, which lies after the first section and the second section, and which includes fewer points than a predetermined threshold value, includes the outlier. In addition, the point cloud processing module 110 may be configured to remove points included in the second intermediate section determined to include the outlier.

According to an exemplary embodiment, the point cloud processing module 110 may be configured to determine the operation mode as the second operation mode. The point cloud processing module 110 may be configured to determine the center point corresponding to a position average of all point belonging to the aligned point cloud, and may be configured to set the plurality of sections in cylindrical shapes, based on a straight line passing through the center point.

In more detail, the point cloud processing module 110 may be configured to set a plurality of first intermediate sections (e.g., layer section) through division into units of the first parameter (e.g., the first parameter represents a vertical thickness) in a vertical direction along a straight line passing through the center point. In addition, the point cloud processing module 110 may be configured to set the plurality of second intermediate sections by dividing the first intermediate section into preset units of the second parameter (e.g., the second parameter represents a horizontal length) in a horizontal direction.

The point cloud processing module 110 may be configured to determine the second intermediate section including the largest number of points, among the plurality of second intermediate sections as the first section.

The point cloud processing module 110 may be configured to generate the refined point cloud from which outlier is removed based on based on the first section and the second section. Specifically, according to an exemplary embodiment, the point cloud processing module 110 may be configured to determine that a second intermediate section among the plurality of second intermediate sections, which lies after the first section and the second section, and which includes fewer points than the predetermined threshold value, includes the outlier. In addition, the point cloud processing module 110 may be configured to remove points included in the second intermediate section determined to include the outlier.

According to an exemplary embodiment, in order to generate the refined point cloud, the point cloud processing module 110 may be configured to determine a first external section that is adjacent to the first intermediate section corresponding to an outer side in an external direction and includes no point, with respect to a first intermediate section corresponding to an outer side among the plurality of first intermediate sections. In addition, the point cloud processing module 110 may be configured to determine that a second external section that lies after the second section and includes fewer points than the predetermined threshold value includes the outlier. Subsequently, the point cloud processing module 110 may be configured to remove points included in the second external section determined to include the outlier.

The final model reconstruction module 120 may be configured to reconstruct the final model, by inputting the refined point cloud into the deep learning model 140, and having the deep learning model 140 predict a 3D mesh. Specifically, the final model reconstruction module 120 may be configured to construct a K-dimensional tree (KD-Tree) space based on a mesh vertex of the 3D mesh. The mesh vertices have coordinates in three-dimensional space, and may be important elements that define the overall shape and structure of the mesh. The KD-Tree is a data structure for efficiently managing and searching the mesh vertices, and may partition the mesh vertices according to specific rules and store them in a tree form.

In addition, the final model reconstruction module 120 may be configured to place a colored point cloud in the KD-Tree space. The colored point cloud has RGB color information for each point, and may be configured to provide data for coloring the 3D mesh. Each point of the colored point cloud may be mapped to the mesh vertex in the KD-Tree, and through this, may allow colors corresponding to each region of the mesh to be assigned.

In addition, the final model reconstruction module 120 may be configured to calculate adjacent points and distances between the adjacent points. The adjacent point may be efficiently searched by using the structure of the KD-Tree, and the color and uncertainty value of the mesh vertex may be estimated based on the calculated distance information. Through this process, the visual consistency of the mesh may be increased, and a final 3D model with color information may be completed.

According to an exemplary embodiment, the final model reconstruction module 120 may be configured to perform color matching by collecting colors of points adjacent to the mesh vertex, and may be configured to reconstruct a colored mesh into the final model.

According to an exemplary embodiment, the final model reconstruction module 120 may be configured to generate a heatmap mesh based on the distance between the adjacent points, and may be configured to reconstruct the heatmap mesh into the final model.

The measurement module 130 may be configured to perform measurement on the cargo by using the final model. The measurement module 130 may be configured to calculate, for example, a water volume with respect to the cargo. The water volume relates to a process of measuring an entire volume occupied by the cargo, and may mean the volume of water occupied by the cargo when the cargo is submerged in a certain water tank. The measurement module 130 may be configured to calculate the water volume by mathematically integrating the interior space of the cargo by using the 3D mesh model, or by estimating the volume based on outer lines and surfaces of the cargo. This function enables accurate volume measurement even when the size or shape of the cargo is irregular, and may provide useful data for calculating the cost of transporting cargo or for establishing loading plans.

According to an exemplary embodiment, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In addition, outliers and noise points occurring due to objects such as glossy vinyl, metal, glass, or the like or a material such as a black color pallet, in the point cloud data collected from 3D camera may be effectively removed. Due to light reflection or absorption of the sensor, these outliers may cause a ghost point at a position where an object does not actually exist, or distortion in the reconstruction result due to missing points, and by removing outliers on the bottom surface as well as omnidirectional outliers distributed on the top and sides of the object, a reconstructed mesh of a better quality can be obtained. In particular, an outlier removal method according to the present embodiment is optimized for objects with complex structures and unevenly distributed points, such as large cargoes, and accordingly, outliers can be accurately removed while minimizing loss of raw points, compared to the conventional outlier removal method, thereby improving the volume accuracy, and also improving the speed of the reconstruction process.

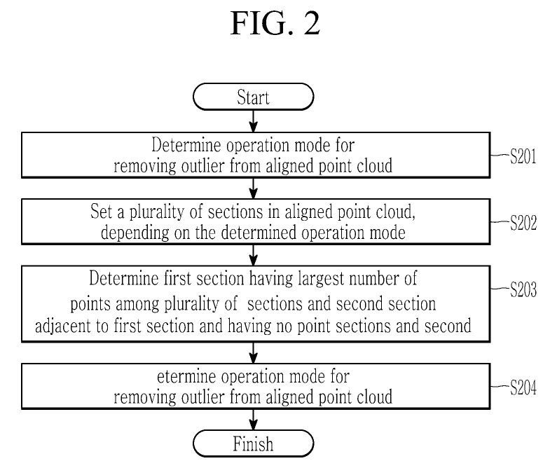

FIG. 2 illustrates a drawing for explaining a method for measuring cargo, according to an exemplary embodiment.

Referring to FIG. 2, a method for measuring cargo, according to an exemplary embodiment, may comprise a step S201 of determining the operation mode for removing the outliers from the aligned point cloud, a step S202 of setting the plurality of sections in the aligned point cloud, according to the determined operation mode, a step S203 of determining the first section having the largest number of points among the plurality of sections and the second section adjacent to the first section and having no point, and a step S204 of generating the refined point cloud from which the outlier is removed based on based on the first section and the second section.

For more detailed information about the above method, reference can be made to the description of the embodiments described in this specification, so a redundant description is not included herein.

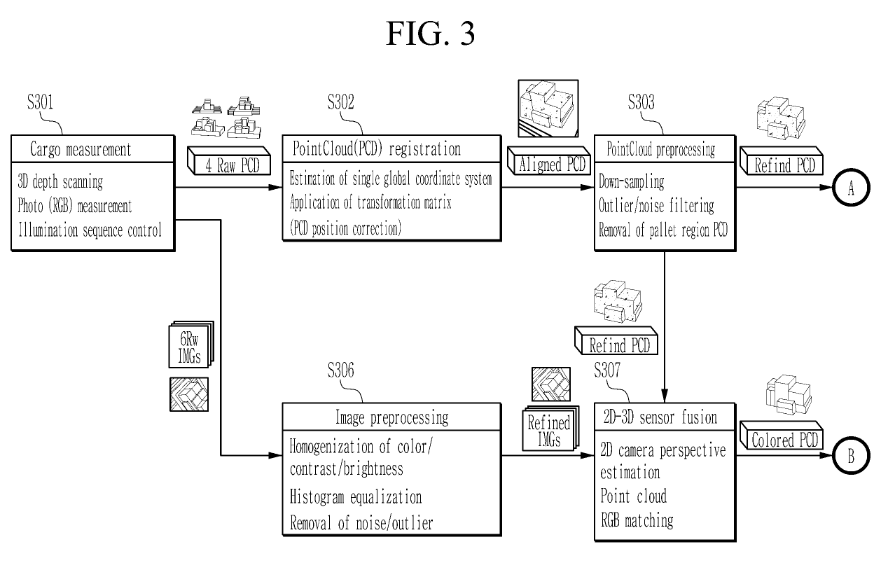

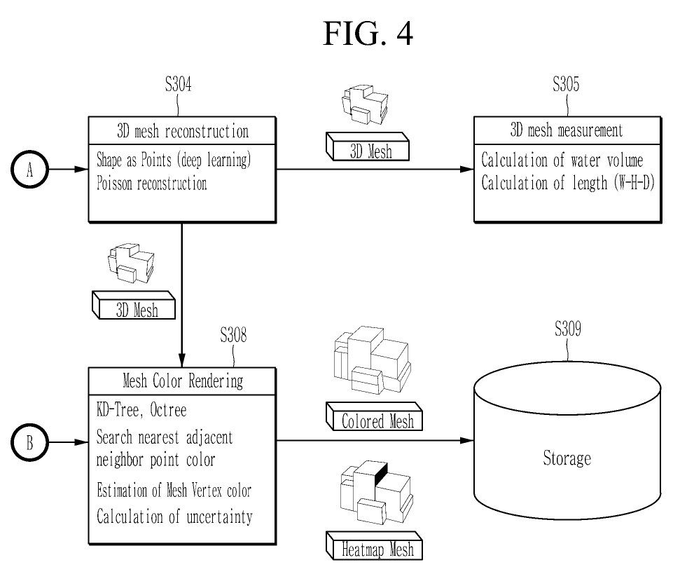

FIGS. 3 and 4 illustrate drawings for explaining a method for measuring cargo, according to an exemplary embodiment.

Referring to FIGS. 3 and 4, a method for measuring cargo, according to an exemplary embodiment, may be configured to perform a cargo measurement step S301. In this step, 3D depth scanning and RGB photographing are performed in order to measure a 3D shape of the cargo. By controlling the illumination sequence, the measurement environment may be optimized, and high-quality data may be collected. Four raw point clouds and six raw images may be output as results.

A step S302 may be a point cloud registration step. This step may be performed by receiving the output of the cargo measurement step S301 as input. The four raw point clouds may be aligned to a single global coordinate system, and a position of each point cloud may be corrected by applying a transformation matrix. Finally, the aligned point cloud may be generated.

A step S303 may be a point cloud preprocessing step. This step may use the results of the point cloud registration step S302 as input. The size of data may be reduced through down-sampling, and the quality of data may be improved by filtering out outliers and noise. In addition, the refined point cloud may be output by removing the point cloud of the pallet region.

A step S304 may be a 3D mesh reconstruction step. In this step, the refined point cloud of the point cloud preprocessing step S303 may be received as input, and the 3D mesh may be generated. A precise 3D mesh may be constructed by utilizing deep learning-based “Shape as Points” and Poisson reconstruction technique. The 3D mesh may be output as results.

A step S305 may be a 3D mesh measurement step. In this step, the measurement work may be performed by using the 3D mesh generated in the 3D mesh reconstruction step S304. By calculating the water volume, and measuring the height, width, and depth (W-H-D) of mesh, the volume and shape of the cargo may be accurately analyzed.

A step S306 may be an image preprocessing step. This step may use the six raw images collected in the cargo measurement step S301 as input. The image quality may be improved by homogenizing the color, contrast, and brightness, and by performing histogram equalization and noise removal. As a result, a refined image may be generated.

A step S307 may be a 2D-3D sensor fusion step. This step may be performed by using the output of the point cloud preprocessing step S303 and the image preprocessing step S306. The colored point cloud may be generated performing perspective estimation of the 2D camera, and matching the point cloud with an RGB image.

A step S308 may a mesh color rendering step. In this step, the 3D mesh generated in the 3D mesh reconstruction step S304 and the colored point cloud of the 2D-3D sensor fusion step S307 may be used as input. In this process, a color of a neighbor point nearest adjacent to each vertex of the mesh may be searched by utilizing the KD-Tree and octree, and the colors of the mesh vertices may be estimated based on this. In addition, the reliability of the mesh may be evaluated by calculating the uncertainty value with respect to the color estimation. As a result, the colored mesh and the heatmap mesh may be generated, so that 3D visualization of the cargo can be strengthened.

A step S309 may be a step of storing the generated mesh. In the last step, the colored mesh and the heatmap mesh generated in the mesh color rendering step S308 may be stored. These may be stored in a database or file system, for later analysis or reference.

In accordance with the above process flow, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

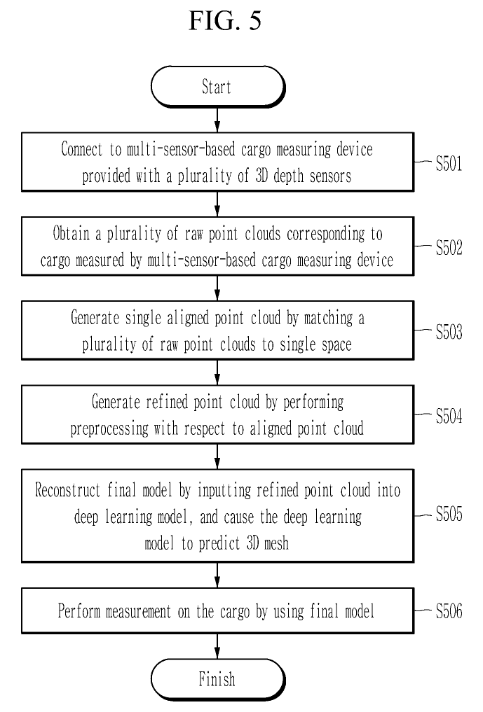

FIG. 5 illustrates a drawing for explaining a method for measuring cargo, according to an exemplary embodiment.

Referring to FIG. 5, a method for measuring cargo, according to an exemplary embodiment, may comprise a step S501 of connecting to the multi-sensor-based cargo measuring device provided with the plurality of 3D depth sensors, a step S502 of obtaining the plurality of raw point clouds corresponding to the cargo measured by the multi-sensor-based cargo measuring device, a step S503 of generating the single aligned point cloud by matching the plurality of raw point clouds to a single space, a step S504 of generating the refined point cloud by performing preprocessing on the aligned point cloud, a step S505 of reconstructing the final model by inputting the refined point cloud into a deep learning model, and causing the deep learning model to predict the 3D mesh, and a step S506 of performing measurement on the cargo by using the final model.

For more detailed information about the above method, reference can be made to the description of the embodiments described in this specification, so a redundant description is not included herein.

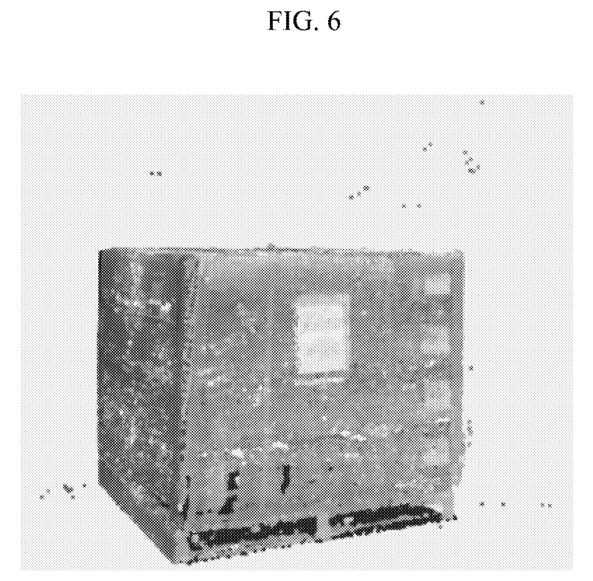

FIGS. 6-11 illustrate drawings for explaining implementation examples of a method and apparatus for measuring cargo, according to an exemplary embodiment.

Referring to FIG. 6, outliers remaining after dividing the bottom surface and the cargo are represented as red points. The point cloud processing module 110 may additionally be configured to remove outlier remaining after dividing the bottom surface and the cargo.

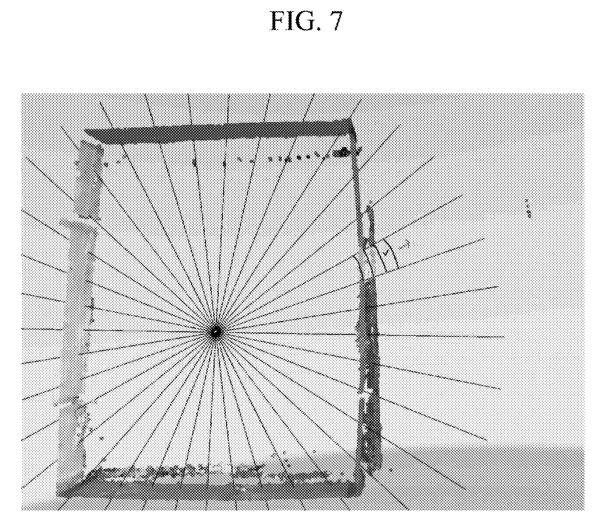

Referring to FIGS. 7 and 8, the point cloud processing module 110 may be configured to set a portion of the aligned point cloud as the region-of-interest, determine the center point corresponding to a position average of all point belonging to the region-of-interest, and set a plurality of radial sections, based on the center point. Specifically, the point cloud processing module 110 may set the first intermediate section (illustrated as “phi_bin”) through division into units of the first parameter preset in the phi direction, based on the center point. In addition, the point cloud processing module 110 may set the plurality of second intermediate sections (illustrated as “rho_bin”) through division into units of the second parameter preset based on the rho value, in the first intermediate section.

The point cloud processing module 110 may be configured to determine the second intermediate section including the largest number of points, among the plurality of second intermediate sections as the first section, and may determine the second section adjacent to the first section and having no point. Afterwards, the point cloud processing module 110 may be configured to determine that a second intermediate section among the plurality of second intermediate sections, which lies after the first section and the second section, and which includes fewer points than the predetermined threshold value, includes the outlier. In addition, the point cloud processing module 110 may be configured to remove points included in the second intermediate section determined to include the outlier.

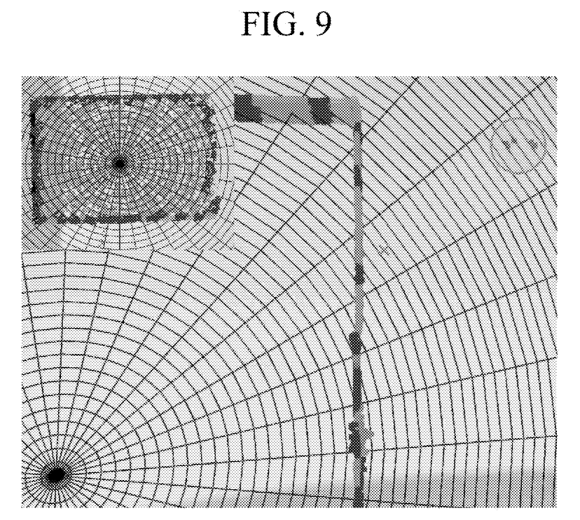

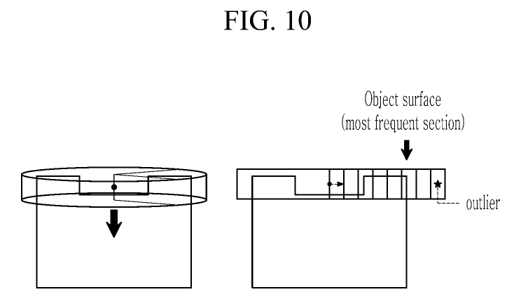

Referring to FIGS. 9 and 10, the point cloud processing module 110 may be configured to determine the center point corresponding to a position average of all point belonging to the aligned point cloud, and be configured to may set the plurality of sections in cylindrical shapes, based on a straight line passing through the center point. Specifically, the point cloud processing module 110 may be configured to set the plurality of first intermediate sections (e.g., layer section) through division into units of the first parameter representing a vertical thickness, in a vertical direction along a straight line passing through the center point. In addition, in the first intermediate section, the point cloud processing module 110 may be configured to set the plurality of second intermediate sections through division into units of the second parameter representing a horizontal length preset in a horizontal direction.

The point cloud processing module 110 may be configured to determine the second intermediate section including the largest number of points, among the plurality of second intermediate sections as the first section. Afterwards, the point cloud processing module 110 may be configured to determine that a second intermediate section among the plurality of second intermediate sections, which lies after the first section and the second section, and which includes fewer points than the predetermined threshold value, includes the outlier. In addition, the point cloud processing module 110 may be configured to remove points included in the second intermediate section determined to include the outlier.

On the other hand, in order to generate the refined point cloud, the point cloud processing module 110 may be configured to determine the first external section adjacent to the first intermediate section corresponding to an outer side in an external direction and having no point, with respect to the first intermediate section corresponding to an outer side among the plurality of first intermediate sections. In addition, the point cloud processing module 110 may be configured to determine that a second external section that lies after the second section and includes fewer points than the predetermined threshold value includes the outlier. Subsequently, the point cloud processing module 110 may be configured to remove points included in the second external section determined to include the outlier.

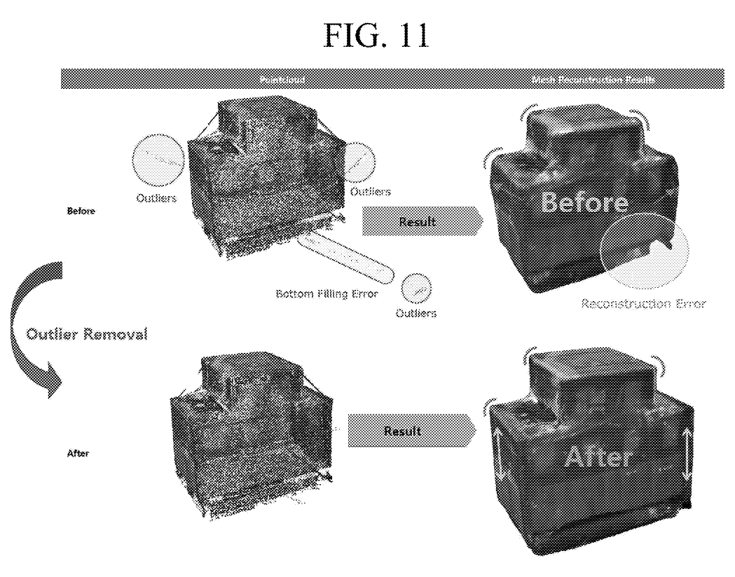

Referring to FIG. 11, it may be seen that the quality of mesh reconstruction is improved by removing the outliers. Specifically, the deterioration of reconstruction quality caused by outliers due to light reflection may be prevented, and more robust reconstruction results can be obtained when outliers are removed for empty spaces caused by improper point collection. This outlier removal method, which is optimized for objects with complex structures and unevenly distributed points, such as large cargoes, may improve the volume accuracy, and may improve the speed of the reconstruction process.

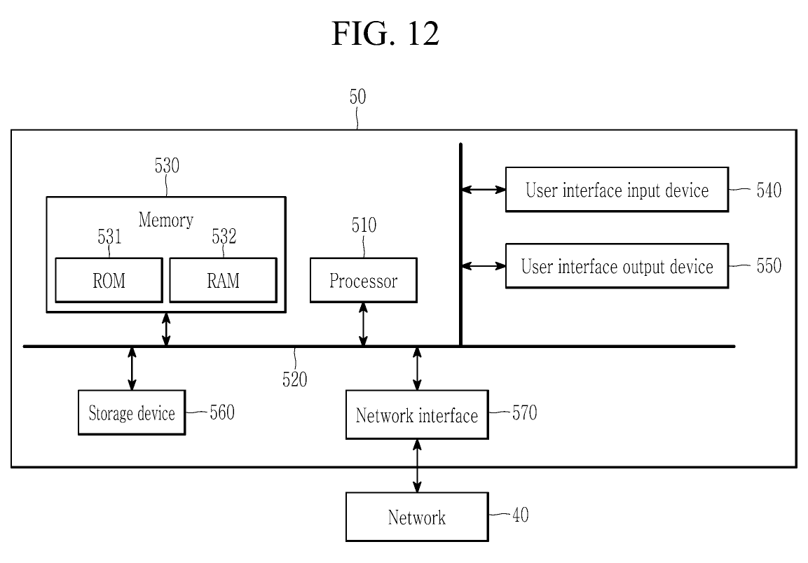

FIG. 12 illustrates a drawing for explaining a computing device, according to an exemplary embodiment.

Referring to FIG. 12, a method and apparatus for measuring cargo, according to an exemplary embodiment, may be implemented by using the computing device 50. The computing device 50 may be implemented as various forms of electronic devices, servers, or similar devices, and its function may be implemented through a combination of software and hardware.

The computing device 50 may comprise at least one of a processor 510, a memory 530, a user interface input device 540, a user interface output device 550, and a storage device 560 that communicate through a bus 520. The computing device 50 may also comprise a network interface 570 electrically connected to the network 40. The network interface 570 may be configured to transmit or receive signals with other entities through the network 40.

The processor 510 may be implemented as various types of computing devices, for example, a micro controller unit (MCU), an application processor (AP), a central processing unit (CPU), a graphics processing unit (GPU), a neural processing unit (NPU), quantum processing unit (QPU), or the like. The processor 510 may comprise a semiconductor device that executes instructions stored in the memory 530 or the storage device 560, and may play a core role of the system. The program code and data stored in the memory 530 or the storage device 560 may be configured to command the processor 510 to perform a specific work, thereby enabling the overall operation of the system. The processor 510 may be configured to implement various functions and methods described above with reference to FIGS. 1-11.

The memory 530 and the storage device 560 may comprise various types of volatile or non-volatile storage media for storing and accessing data of the system. For example, the memory 530 may comprise a read-only memory (ROM) 531 and a random-access memory (RAM) 532. According to an exemplary embodiment, the memory 530 may be built into the processor 510, in which case, the data transmission speed between the memory 530 and the processor 510 may be very fast. According to an exemplary embodiment, the memory 530 may be located outside the processor 510, in which case, the memory 530 may be connected to the processor 510 through various data buses or interfaces. This connection may be made through already known various means, for example, a Peripheral Component Interconnect Express (PCIe) interface for high-rate data transmission or a memory controller.

According to an exemplary embodiment, at least some of components or functions of a method and apparatus for measuring cargo, according to an exemplary embodiment, may be implemented as a program or software executed by the computing device 50, and the program or software may be stored in computer-readable recording medium or storage medium. Specifically, a computer-readable recording medium or storage medium, according to an exemplary embodiment, may be configured to record a program for executing steps included in an implementation of the method and apparatus for measuring cargo according to embodiments, on a computer including the processor 510 executing a program or instructions stored in the memory 530 or the storage device 560.

According to an exemplary embodiment, at least some of components or functions of a method and apparatus for measuring cargo according to embodiments may be implemented by using hardware or circuitry of the computing device 50, or may implemented as separate hardware or circuitry that may be electrically connected to the computing device 50.

According to an exemplary embodiment, one or more non-transitory computer-readable media including an instruction executable by a computing device 50 may be provided, where the instruction may cause the computing device 50 to perform the operation when executed by one or more processors of the computing device 50. Here, the operation may include components, functions, steps, or the like, described in this specification with respect to a method and apparatus for measuring cargo according to embodiments.

According to an exemplary embodiment, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In addition, according to an embodiment, the outliers and noise points occurring due to objects such as glossy vinyl, metal, glass, or the like or a material such as a black color pallet, in the point cloud data collected from 3D camera may be effectively removed. Due to light reflection or absorption of the sensor, these outliers may cause a ghost point at a position where an object does not actually exist, or distortion in the reconstruction result due to missing points, and by removing outliers on the bottom surface as well as omnidirectional outliers distributed on the top and sides of the object, a reconstructed mesh of a better quality can be obtained. In particular, an outlier removal method according to the present embodiment is optimized for objects with complex structures and unevenly distributed points, such as large cargoes, and accordingly, outliers can be accurately removed while minimizing loss of raw points, compared to the conventional outlier removal method, thereby improving the volume accuracy, and also improving the speed of the reconstruction process.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A method for measuring cargo, comprising:
using a computing device comprising a processor and a memory:
obtaining a plurality of raw point clouds corresponding to cargo measured by a multi-sensor-based cargo measuring device provided with a plurality of 3D depth sensors;
generating a single aligned point cloud by matching the plurality of raw point clouds to a single space;
determining an operation mode for removing an outlier from the aligned point cloud;
setting a plurality of sections in the aligned point cloud, depending on the determined operation mode;
determining a first section including a largest number of points, from among the plurality of sections;
determining a second section adjacent to the first section and having no points;
generating a refined point cloud from which the outlier is removed based on based on the first section and the second section;
reconstructing a final model by inputting the refined point cloud into a deep learning model, causing the deep learning model to predict a 3D mesh; and
performing a measurement with respect to the cargo by using the final model.

2. The method of claim 1, wherein:
the determining the operation mode comprises determining the operation mode as a first operation mode, and
the setting the plurality of sections comprises:
setting a portion of the aligned point cloud as a region-of-interest;
determining a center point corresponding to a position average of all points belonging to the region-of-interest; and
setting a plurality of radial sections, based on the center point.

3. The method of claim 2, wherein the setting the plurality of radial sections comprises:
setting of a first intermediate section, through division into preset units of a first parameter unit in a phi direction, based on the center point; and
setting a plurality of second intermediate sections by dividing the first intermediate section into preset units of a second parameter based on a rho value.

4. The method of claim 3, wherein the determining the first section comprises determining the second intermediate section including the largest number of points, among the plurality of second intermediate sections as the first section.

5. The method of claim 4, wherein the generating the refined point cloud comprises:
determining that a second intermediate section among the plurality of second intermediate sections, which lies after the first section and the second section, and which comprises fewer points than a predetermined threshold value, includes the outlier; and
removing a point included in the second intermediate section determined to include the outlier.

6. The method of claim 1, wherein:
the determining the operation mode comprises determining the operation mode as a second operation mode, and
the setting the plurality of sections comprises:
determining a center point corresponding to a position average of all points belonging to the aligned point cloud; and
setting the plurality of sections in a cylindrical shape, based on a straight line passing through the center point.

7. The method of claim 6, wherein the setting the plurality of sections of the cylindrical shape comprises:
setting a plurality of first intermediate sections through division into units of a first parameter in a vertical direction along a straight line passing through the center point; and
setting a plurality of second intermediate sections by dividing the first intermediate section into preset units of a second parameter in a horizontal direction.

8. The method of claim 7, wherein the determining the first section comprises: determining the second intermediate section including the largest number of points, among the plurality of second intermediate sections as the first section.

9. The method of claim 8, wherein the generating the refined point cloud comprises:
determining that a second intermediate section among the plurality of second intermediate sections, which lies after the first section and the second section, and which comprises fewer points than a predetermined threshold value, includes the outlier; and
removing a point included in the second intermediate section determined to include the outlier.

10. The method of claim 7, wherein the generating the refined point cloud comprises:
determining a first external section that is adjacent to the first intermediate section corresponding to an outer side in an external direction and includes no point, with respect to a first intermediate section corresponding to an outer side among the plurality of first intermediate sections;
determining that a second external section that lies after the second section and comprises fewer points than a predetermined threshold value includes the outlier; and
removing a point included in the second external section determined to include the outlier.

11. An apparatus for measuring cargo, comprising:
a computing device, comprising a processor and a memory, the computing device being configured to:
obtain a plurality of raw point clouds corresponding to cargo measured by a multi-sensor-based cargo measuring device provided with a plurality of 3D depth sensors;
generate a single aligned point cloud by matching the plurality of raw point clouds to a single space;
determine an operation mode for removing an outlier from the aligned point cloud;
set a plurality of sections in the aligned point cloud, depending on the determined operation mode;
determine a first section including the largest number of points, from among the plurality of sections;
determine a second section adjacent to the first section and having no point;
generate a refined point cloud from which the outlier is removed based on based on the first section and the second section;
reconstruct a final model by inputting the refined point cloud into a deep learning model, and causing the deep learning model to predict a 3D mesh; and
perform a measurement with respect to the cargo by using the final model.

12. The apparatus of claim 11, wherein:
the determining the operation mode comprises determining the operation mode as a first operation mode, and
the setting the plurality of sections comprises:
setting a portion of the aligned point cloud as a region-of-interest;
determining a center point corresponding to a position average of all points belonging to the region-of-interest; and
setting a plurality of radial sections, based on the center point.

13. The apparatus of claim 12, wherein the setting the plurality of radial sections comprises:
setting a first intermediate section, through division into preset units of a first parameter unit in a phi direction, based on the center point; and
setting a plurality of second intermediate sections by dividing the first intermediate section into preset units of a second parameter based on a rho value.

14. The apparatus of claim 13, wherein the determining the first section comprises determining the second intermediate section including the largest number of points, among the plurality of second intermediate sections as the first section.

15. The apparatus of claim 14, wherein the generating the refined point cloud comprises:
determining that a second intermediate section among the plurality of second intermediate sections, which lies after the first section and the second section, and which comprises fewer points than a predetermined threshold value, includes the outlier; and
removing a point included in the second intermediate section determined to include the outlier.

16. The apparatus of claim 11, wherein:
the determining the operation mode comprises determining the operation mode as a second operation mode, and
the setting the plurality of sections comprises:
determining a center point corresponding to a position average of all points belonging to the aligned point cloud; and
setting the plurality of sections in a cylindrical shape, based on a straight line passing through the center point.

17. The apparatus of claim 16, wherein the setting the plurality of sections of the cylindrical shape comprises:
setting a plurality of first intermediate sections through division into units of a first parameter in a vertical direction along a straight line passing through the center point; and
setting a plurality of second intermediate sections by dividing the first intermediate section into preset units of a second parameter in a horizontal direction.

18. The apparatus of claim 17, wherein the determining the first section comprises determining the second intermediate section including the largest number of points, among the plurality of second intermediate sections as the first section.

19. The apparatus of claim 18, wherein the generating the refined point cloud comprises:
determining that a second intermediate section among the plurality of second intermediate sections, which lies after the first section and the second section, and which comprises fewer points than a predetermined threshold value, includes the outlier; and
removing a point included in the second intermediate section determined to include the outlier.

20. A computing device, comprising:
a processor; and
a memory,
wherein the memory is configured to store instructions that, when executed by the processor, are configured to cause the processor to:
obtain a plurality of raw point clouds corresponding to cargo measured by a multi-sensor-based cargo measuring device provided with a plurality of 3D depth sensors;
generate a single aligned point cloud by matching the plurality of raw point clouds to a single space;
determine an operation mode for removing an outlier from the aligned point cloud;
set a plurality of sections in the aligned point cloud, depending on the determined operation mode;
determine a first section including the largest number of points, from among the plurality of sections;
determine a second section adjacent to the first section and having no points;
generate a refined point cloud from which the outlier is removed based on based on the first section and the second section;
reconstruct a final model by inputting the refined point cloud into a deep learning model, and causing the deep learning model to predict a 3D mesh; and
perform a measurement with respect to the cargo by using the final model.
